(19) United States
(12) Patent Application Publication
(10) Pub. No.: US 2015/0042982 A1
(43) Pub. Date: Feb. 12, 2015

(54) PORTABLE DEVICE FOR ANALYSING A PLURALITY OF WIDELY SPACED LASER BEAMS

(71) Applicants: Jean Fortin, Levis (CA); Grégoire Tremblay, Quebec City (CA)

(72) Inventors: Jean Fortin, Levis (CA); Grégoire Tremblay, Quebec City (CA)

(73) Assignee: Her Majesty the Queen in Right of Canada, as Represented by the Minister of National Defence, Ottawa (CA)

(21) Appl. No.: 14/385,476

(22) PCT Filed: Mar. 16, 2012
(86) PCT No.: PCT/CA2012/000249

§ 371 Date: Sep. 15, 2014

(51) Int. Cl. G01M 11/02; G01J 3/28; G01S 3/789; G01J 9/02

(52) U.S. Cl. CPC G01M 11/0207; G01J 9/02; G01J 3/28; G01S 3/789
USPC 356/73

(57) ABSTRACT

A system and method for performing field measurement and testing of a plurality of widely spaced laser beams used in visual warning technology (VWT). VWT uses a combination of widely spaced laser beams, to warn civilians from approaching too close to military security areas. The widely spaced laser beams are displaced using rhomboidal prisms. Each rhomboidal prism receives a corresponding laser beam and displaces it toward a collecting lens. The lens focuses the displaced beams received thereon onto an imaging sensor for testing. Beam shutters may be used for selectively blocking one or more beams in order to test the beams separately and in different combinations.

### BACKGROUND

(a) Field

The subject matter disclosed generally relates to a method and apparatus for analyzing the characteristics of laser beams used in visual warning technology (VWT).

(b) Related Prior Art

Visual warning technology (VWT) is used in military applications to warn the local population from approaching too close to military security areas where the presence of people might be mistakenly interpreted as being hostile and deadly force might be unnecessarily used against peaceful civilians. The MT uses a combination of widely spaced laser beams, which when combined, result in an intense visible light to get the attention of pedestrians and vehicle drivers at secure distances, and in bright daylight conditions.

To achieve the irradiance level required to get the individual's attention and avoid damaging the retina of the individuals at which the laser is aimed, the VWT device produces a set of four or more widely spaced beams with reduced intensity. The spacing is set as to spread the signal over different points/areas of the retina at the minimum operating range and minimize the safety concerns.

In order to insure safe use of this technology in the field, a strict set of rules has been adopted prior to deployment and also during usage in the field. Laser safety assessment requires rapid/accurate measurement of laser beam characteristics such as power, divergence, modulation, etc.

The main challenge posed by the measurement relates to the large spacing between the beams and the need to perform the testing in the field during usage. Periodic testing in the field is required because the characteristics of the beams can change due to many reasons including degradation of the diodes and other reasons which are known for someone skilled in the art.

Existing systems for testing a plurality of laser beams spaced by large distances are very expensive and very large in size such that they may not be used in the field. In other words they are too big and too expensive to be field deployable.

FIG. 1 illustrates a conventional system for testing the characteristics of a plurality of laser beams in the lab. The system of FIG. 1 comprises an off axis parabolic mirror to collect the different laser beams and a secondary mirror for bending the optical path prior to create an image of the resulting beam on an imaging sensor. In this device, the parabolic mirror must be large enough to comprise the beams, which results in a very large and very expensive device.

Other systems use a converging lens for each two beams to direct the beams toward an imaging device. The problem with this approach is that it requires a lens and one imaging sensor for each two beams, and thus two lenses and two imaging sensors for the four beams. These systems are difficult to calibrate and expensive as they require more equipment. Furthermore, they require greater linear space between the lens and the imaging sensor (compared to the system of FIG. 1). Furthermore, they lead to large incident angle between the beams and the imaging sensor which increases calculation errors.

Therefore, there is a need for a portable and ruggedized device for testing the characteristics of a plurality of laser beams.

### SUMMARY

According to an embodiment, there is provided a portable testing device for selectively measuring characteristics of one or more of a plurality of widely spaced laser beams of a visual warning technology (VWT) device, the portable testing device comprising: a casing having a plurality of first openings each for receiving one of the plurality of widely spaced laser beams; beam shutters for blocking one or more laser beams; rhomboidal prisms positioned to receive the widely spaced laser beams and displace them closer to each other; an imaging sensor for measuring characteristics of laser beams received thereon; and a lens for focusing the displaced laser beams on the imaging sensor.

In an embodiment, the portable testing device may further comprise a U-shaped support installed within the casing of the portable testing device and wherein the beam shutters, the rhomboidal prisms, the imaging sensor, and the lens are attached to the U-Shaped support.

In another embodiment, the U-shaped support may define a first wall including a plurality of second openings which are aligned with the first openings, wherein the beam shutters are mounted on the first wall for selectively blocking the one or more of a plurality of widely spaced laser beams.

The beam shutters may be controlled by motors. In an embodiment, at least one of the beam shutters is T-shaped and dimensioned to controls two of the plurality of second openings.

In an embodiment, the device may further comprise a mount for receiving the VWT device thereon to directly align each beam with a corresponding first opening and a corresponding second opening.

In a further embodiment, the device may further comprise a filter mount attached to the imaging sensor, the filter mount comprising a plurality of slots for inserting optical filters therein for filtering the laser beams before reaching the imaging sensor.

In yet another embodiment, the device may further comprise an optical filter for filtering the laser beams before reaching the imaging sensor.

In another embodiment, the device may include a handle for carrying the device in the field.

In another aspect, there is provided portable a testing device for measuring characteristics of one or more of a plurality of widely spaced laser beams of a visual warning technology (VWT) device, the portable testing device comprising: a casing having a plurality of openings each for receiving one of the plurality of widely spaced laser beams; rhomboidal prisms positioned within the casing to receive the plurality of widely spaced laser beams through a respective one of the plurality of openings and displace them closer to each other; an imaging sensor for measuring characteristics of laser beams received thereon; and a lens for focusing the displaced laser beams on the imaging sensor.

The longitudinal axes of the rhomboidal prisms may be substantially parallel to a plane of the lens and substantially perpendicular to the beams received thereon.

In an embodiment, each rhomboidal prism has one end which is aligned with a corresponding opening for receiving a corresponding beam and a second end opposite the first end, the second end being positioned to reflect the corresponding beam onto the lens.

In another aspect, there is provided A portable testing device for measuring characteristics of one or more of a plurality of widely spaced laser beams of a visual warning technology (VWT) device, the portable testing device comprising: a lens; rhomboidal prisms positioned to receive individual ones of the plurality of widely spaced laser beams and displace them toward the lens; an imaging sensor for measuring characteristics of laser beams received thereon; wherein the lens is provided between the rhomboidal prisms and the imaging sensor and positioned to receive the displaced laser beams and focus them onto the imaging sensor

In yet a further aspect, there is provided a method for performing field measurements of characteristics of a plurality of widely spaced laser beams emitted by a visual warning technology (VWT) device, the method comprising: receiving widely spaced laser beams at a testing device; individually displacing each one of the plurality of widely spaced laser beams toward a collecting lens using rhomboidal prisms; focusing the beams on an imaging sensor for measuring the characteristics.

The method may further comprise blocking selected beams for testing the beams separately and in different combinations.

In an embodiment, blocking comprises selectively controlling the beams using motor controlled beam shutters.

In a further embodiment, the method comprises filtering the beams prior to reaching the imaging sensor for avoiding saturation.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates a conventional prior art system for testing the characteristics of a plurality of laser beams in the lab;

FIG. 2 is an image of a portable device for testing the characteristics of a plurality of laser beams, in accordance with an embodiment;

FIG. 3 is an image of the device of FIG. 2 with the VWT device installed thereon;

FIG. 4 illustrates the reflection of a laser beam in a rhomboidal prism;

FIG. 5 illustrates the focusing of a plurality of widely spaced laser beams toward a single imaging sensor using a portable device in accordance with an embodiment;

FIG. 6 illustrates an exemplary implementation of motor activated beam shutters in the portable testing device;

FIG. 7 is a top view of a testing device during operation; and

FIG. 8 is flowchart of a method for performing field measurements of a plurality of widely spaced laser beams emitted by a visual warning technology (VWT) device.

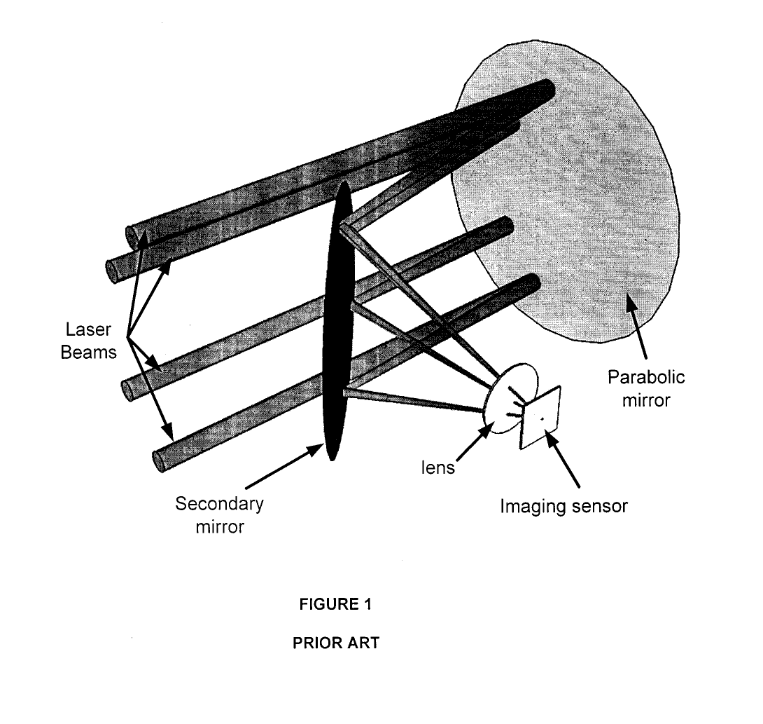

It will be noted that throughout the appended drawings, like features are identified by like reference numerals.

### DETAILED DESCRIPTION

In embodiments there are disclosed a system and method for performing field measurement and testing of a plurality of widely spaced laser beams used in visual warning technology (VWT). VWT uses a combination of widely spaced laser beams to warn civilians from approaching too close to military security areas. In an embodiment, the widely spaced laser beams are displaced using rhomboidal prisms. Each rhomboidal prism receives a corresponding laser beam and displaces it toward a collecting lens. The lens focuses the displaced beams received thereon onto an imaging sensor for testing. Beam shutters may be used for selectively blocking one or more beams in order to test the beams separately and in different combinations.

The following examples describe a non-limiting implementation of a portable and ruggedized device for testing the characteristics of four laser beams forming a trapezoid. However, it should be noted that the embodiments may be implemented with any number of laser beams, forming any regular or irregular shape.

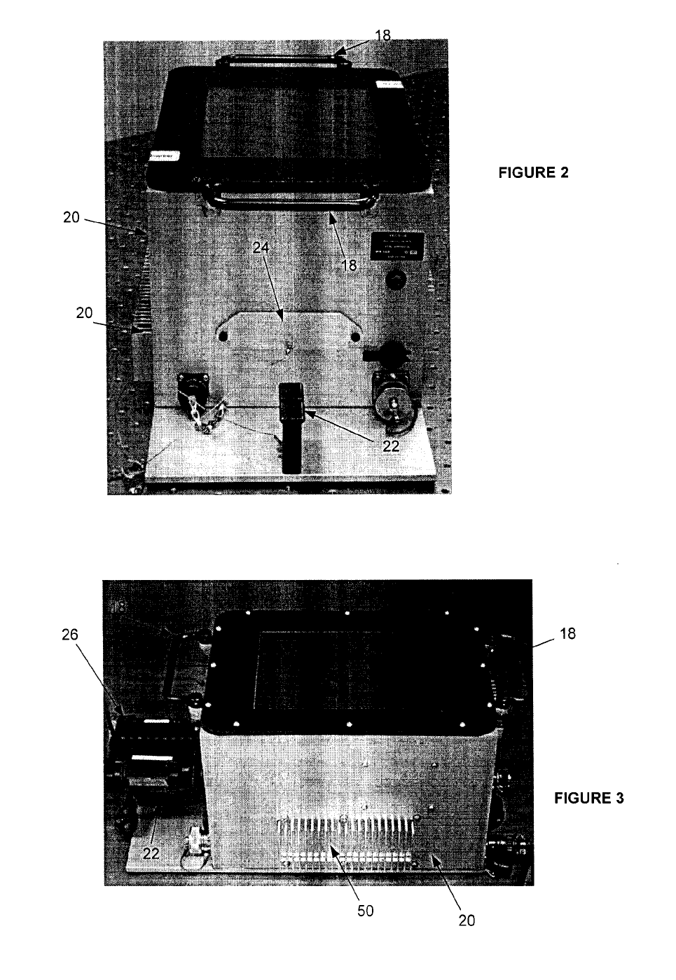

FIG. 2 is an image of a portable testing device 20 for testing the characteristics of a plurality of laser beams, in accordance with an embodiment. In an embodiment, the device 20 defines a casing 21 having a plurality of apertures in one of its sides for receiving the laser beams that are to be tested. As shown in FIG. 2, the device includes a mount 22 for mounting the VWT device thereon for aligning the laser beams emitted by the VWT device with the apertures provided in the casing which are hidden under the cover 24. FIG. 3 is an image of the portable testing device of FIG. 2 with the VWT device installed thereon. In an embodiment, the mount 22 is shaped and dimensioned to allow for an automatic alignment between the laser beams of the WIT device and the apertures, when the VWT device is placed/installed on the mount 22.

In an embodiment, the widely spaced laser beams are brought closer to each other using rhomboidal prisms. A rhomboidal prism may shift/displace the laser beam without affecting its properties or direction. The displaced beams may then be directed to a converging lens to be focused toward an imaging sensor for analysis.

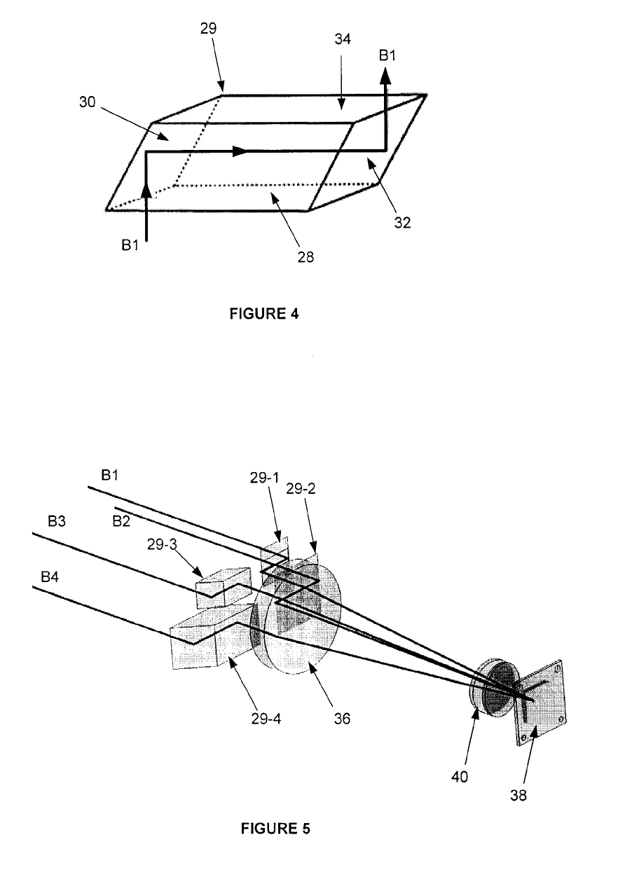

FIG. 4 illustrates the reflection of a laser beam in a rhomboidal prism. As shown in FIG. 4, a laser beam B1 is received at the lower side 28 of a rhomboidal prism 29. The beam B1 is then reflected internally by the side 30 then the side 32 to exit from the upper side 34. As shown in FIG. 4, the beam B1 exits the rhomboidal prism 29 in the same direction (parallel) it entered it.

FIG. 5 illustrates the conceptual focusing of a plurality of widely spaced laser beams toward a single imaging sensor in a portable testing device in accordance with the present embodiments. As shown in FIG. 5, a set of widely spaced laser beams B1 to B4 are displaced closer to each other using rhomboidal prisms 29-1 to 29-4, respectively. The displaced beams B1 to B4 are then directed toward a collecting lens 36 which focuses them onto an imaging device 38. Optionally, the beams may pass through one or more filters 40 prior to reaching the surface of the imaging sensor 38 to bring their characteristics within the operating range of the sensor. The device may include a filter mount defining one or more slots for releasably inserting one or more filters between the imaging sensor and the collecting lens 36.

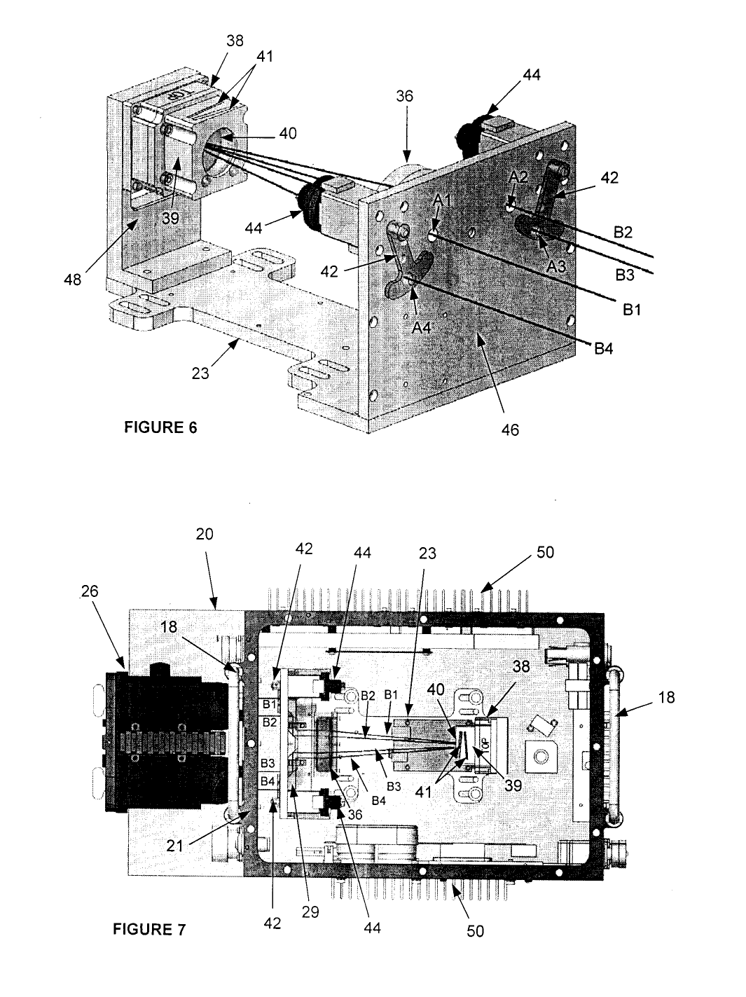

As stated above, it is required to test the beams separately, as well as in the different combinations. In an embodiment, the testing device 20 may comprise a plurality of beam shutters for blocking or opening the path of selected beams before arriving at the collecting lens 36. In an embodiment, the beam shutters are motor operated and provided within device 20 in a way that allows for blocking the selected beams before the beams arrive at the rhomboidal prisms. An exemplary implementation of motor activated beam shutters is illustrated in FIG. 6.

FIG. 6 illustrates a U-shaped support 23 for installing within the casing 21 of the testing device 20, in an embodiment. The support 23 defines four openings A1 to A4 in a wall 46. When the support 23 is installed within the device 20 the openings A1 to A4 would align with the apertures provided in the casing 21 for receiving therethrough the four beams B1 to B4 of the VWT device 26 respectively.

The U-shaped support 23 may include two T-shaped beam shutters 42 which are rotatably connected to motors 44. In the example of FIG. 6, each beam shutter is shaped and dimensioned to control two holes e.g., A1 & A4, A2 & A3, by blocking or clearing one of the holes or both of them by performing certain rotations. As shown in FIG. 6, the imaging sensor 38 is provided at the opposite wall 48 for receiving the beams B1 to B4 received through the holes A1 to A4 of the wall 46, after they are converged by the collecting lens 36. An optical filter mount 39 may be mounted on the imaging sensor 38. The filter mount 39 may include a plurality of slots 41 for inserting optical filters 40 therein for filtering the beams before reaching the imaging sensor 38.

The support 23 may include other openings throughout the body thereof for receiving other parts of the testing device 20 and for being secured within the casing 21 of the testing device 20, as shown in FIG. 7.

FIG. 7 is a top view of a testing device during operation. FIG. 7 illustrates a testing device 20 with a VWT device 26 installed thereon. The VWT device 26 emits four laser beams B1, B2, B3 and B4. The beams B1 to B4 pass through the apertures provided in the wall of the casing 21 to be received at the openings A1 to A4 at the wall 46 of the support 23. Selected beams that pass through the beam shutters 42 are displaced by rhomboidal prisms 29, received at the collecting lens 36 and then focused toward the imaging sensor 38. The beams may be filtered by filters 40 inserted in the slots 41 of a filter mount 39 installed on the imaging sensor 38.

The imaging sensor 38 may include or may be connected to an electronic circuit or computing device (not shown) to perform the necessary testing of wavelength, intensity, shape, modulation, divergence, alignment, etc. The testing device 20 may include a plurality of heat sinks 50 provided at the exterior of the casing 21 for reducing the temperature of the device 20. The testing device 20 may also include handles 18 for carrying and deploying the testing device 20 in the field.

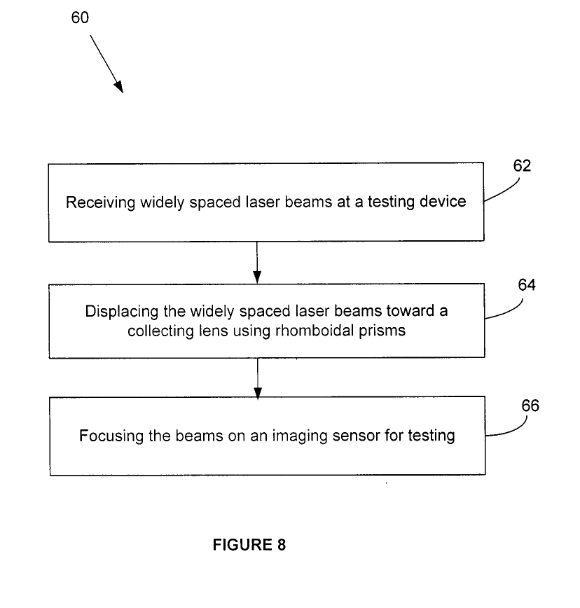

FIG. 8 is a flowchart of a method for performing field measurements of characteristics of a plurality of widely spaced laser beams emitted by a visual warning technology (VWT) device. At step 62 the method comprises receiving widely spaced laser beams at a testing device. Step 64 comprises individually displacing each one of the plurality of widely spaced laser beams toward a collecting lens using rhomboidal prisms. Step 66 comprises focusing the beams on an imaging sensor for measuring the characteristics.

The method may also comprise blocking selected beams for testing the beams separately and in different combinations. Blocking may comprise selectively controlling the beams using motor controlled beam shutters.

In another embodiment, the method may further comprise filtering the beams prior to reaching the imaging sensor for avoiding saturation.

Accordingly, the embodiments describe a field deployable, ruggedized and portable testing device which allows for testing a plurality of widely spaced laser beams without requiring large mirrors or lenses. Furthermore, a testing device in accordance with the present embodiments allows for improved accuracy. As shown in FIGS. 5 and 6, the incident angle of the beams with the imaging sensor is negligible due to the displacement of the beams closer to each other, which increases the accuracy of the readings at the imaging sensor 38 and reduces measurement errors.

While preferred embodiments have been described above and illustrated in the accompanying drawings, it will be evident to those skilled in the art that modifications may be made without departing from this disclosure. Such modifications are considered as possible variants comprised in the scope of the disclosure.

For example, it is possible to provide the beam shutters at the inner wall of the casing 21 instead of on the wall 46 of the U-Shaped support 23.

Furthermore, it is possible to install the elements mounted on the U-shaped support directly on the chassis of the casing 21 without using the U-shaped support.

Moreover, it is possible to provide the rhomboidal prisms on the inner walls of the casing 21 and then selectively block or clear the path of the displaced beams prior to the beams reaching the collecting lens 36.

It is also possible to effect minor variations to the testing device to accommodate for a different VWT device having a larger or smaller number of beams, and larger or smaller space between the beams, and having differently disposed beams that define a circle, rectangle, square, etc. or any regular or irregular shape.

1. A portable testing device for selectively measuring characteristics of one or more of a plurality of widely spaced laser beams of a visual warning technology (VWT) device, the portable testing device comprising:
a casing having a plurality of first openings each for receiving one of the plurality of widely spaced laser beams;
beam shutters for blocking one or more laser beams;
rhomboidal prisms positioned to receive the widely spaced laser beams and displace them closer to each other;
an imaging sensor for measuring characteristics of laser beams received thereon; and
a lens for focusing the displaced laser beams on the imaging sensor.

2. The portable testing device of claim 1, further comprising a U-shaped support installed within the casing of the portable testing device and wherein the beam shutters, the rhomboidal prisms, the imaging sensor, and the lens are attached to the U-Shaped support.

3. The portable testing device of claim 2, wherein the U-shaped support defines a first wall including a plurality of second openings which are aligned with the first openings, wherein the beam shutters are mounted on the first wall for selectively blocking the one or more of a plurality of widely spaced laser beams.

4. The portable testing device of claim 3, wherein the beam shutters are controlled by motors.

5. The portable testing device of claim 3, wherein at least one of the beam shutters is T-shaped and dimensioned to controls two of the plurality of second openings.

6. The portable testing device of claim 1, further comprising a mount for receiving the VWT device thereon to directly align each beam with a corresponding first opening and a corresponding second opening.

7. The portable testing device of claim 1, further comprising a filter mount attached to the imaging sensor, the filter mount comprising a plurality of slots for inserting optical filters therein for filtering the laser beams before reaching the imaging sensor.

8. The portable testing device of claim 1, further comprising an optical filter for filtering the laser beams before reaching the imaging sensor.

9. The portable testing device of claim 1, further comprising a handle for carrying the device in the field.

10. A portable testing device for measuring characteristics of one or more of a plurality of widely spaced laser beams of a visual warning technology (VWT) device, the portable testing device comprising:
a casing having a plurality of openings each for receiving one of the plurality of widely spaced laser beams;
rhomboidal prisms positioned within the casing to receive the plurality of widely spaced laser beams through a respective one of the plurality of openings and displace them closer to each other;
an imaging sensor for measuring characteristics of laser beams received thereon; and
a lens for focusing the displaced laser beams on the imaging sensor.

11. The portable testing device of claim 10, wherein longitudinal axes of the rhomboidal prisms are substantially parallel to a plane of the lens and substantially perpendicular to the beams received thereon.

12. The portable testing device of claim 11, wherein each rhomboidal prism has one end which is aligned with a corresponding opening for receiving a corresponding beam and a second end opposite the first end, the second end being positioned to reflect the corresponding beam onto the lens.

13. (canceled)

14. The method of claim 13, further comprising blocking selected beams for testing the beams separately and in different combinations.

15. The method of claim 14, wherein blocking comprises selectively controlling the beams using motor controlled beam shutters.

16. The method of claim 13, further comprising filtering the beams prior to reaching the imaging sensor for avoiding saturation.
